(19) United States
(12) Patent Application Publication
(10) Pub. No.: US 2025/0140494 A1
(43) Pub. Date: May 1, 2025

(54) KEYSWITCH STRUCTURE

(71) Applicant: Darfon Electronics Corp., Taoyuan City (TW)

(72) Inventors: LI-YEN NING, Taoyuan City (TW); CHIN-HUNG LIN, Taoyuan City (TW); CHIA-FU CHENG, Taoyuan City (TW)

(21) Appl. No.: 18/931,160

(22) Filed: Oct. 30, 2024

Related U.S. Application Data
(60) Provisional application No. 63/594,057, filed on Oct. 30, 2023.

(30) Foreign Application Priority Data
Oct. 30, 2024 (TW) 113141666

(51) Int. Cl. H01H 13/85; H01H 13/14

(52) U.S. Cl. CPC H01H 13/85; H01H 13/14; H01H 2215/03

(57) ABSTRACT

A keyswitch structure includes a keycap, a baseplate, a support mechanism including pivotally coupled first frame and second frame, a cam portion disposed on the keycap or the first frame, a restoring member providing a restoring force, and a sound-generating unit including a holder and a sound-generating member mounted on the holder. The first frame has a shaft hole defining a shaft rotatably coupled to the keycap. The sound-generating unit has an extending arm extending corresponding to an impact portion of the holder. In a plane view, the extending arm is located at an inner side of the first frame and an outer side of the inner edge of the shaft hole. When the keycap moves toward the baseplate, the cam portion presses the extending arm downward, and then the extending arm is released from the cam portion and bounces upward to hit the impact portion to generate a sound.

### CROSS-REFERENCE TO RELATED APPLICATION

This application claims the priority benefits of Taiwan patent application serial No. 113141666, filed on Nov. 30, 2024, and also claims the priority benefits of U.S. provisional application Ser. No. 63/594,057, filed Oct. 30, 2023. The entirety of the mentioned above patent applications is hereby incorporated by reference herein and made a part of this specification.

### BACKGROUND OF THE INVENTION

### 1. Field of the Invention

The invention generally relates to a keyswitch structure. Particularly, the invention relates to a keyswitch structure capable of providing a pressing sound and a more uniform tactile feedback.

### 2. Description of the Prior Art

Conventional keyboards have relatively high key shafts and pressing strokes, so the keyswitch structure has enough structural space to install a torsion spring or a leaf spring as the tactile and/or sound feedback member, and the key shaft can be designed to have a protrusion structure to interfere with the tactile and/or sound feedback member. However, simply employing the tactile and/or sound feedback member to the ultra-thin keyswitch structure will encounter many technical problems. For example, the keyswitch adopting the scissors-type support frame itself has a resilient restoring member. The structure strength of the keycap and the support frame may be not enough to withstand the upward forces of the resilient restoring member and the tactile/sound feedback member, resulting in deformation of the support frame, such as bending, and failing to accurately transmit the pressing force from the finger.

Moreover, the employment of the tactile/sound feedback member is prone to uneven upward forces through the entire bottom surface of the keycap, resulting in different tactile feedbacks at corners of the keycap. Consequently, the difference in driving properties of the coroners of the keycap leads to different triggering points. In addition, to design a scissors-type support frame with adjustable tactile/sound feedback, it means squeezing out extra moving space in a low, flat and thin keyswitch space, which is another big challenge of the ultra-thin keyswitch structure.

### SUMMARY OF THE INVENTION

It is an object of the invention to provide a keyswitch structure, which not only provides the pressing sound feedback, but also promotes the uniformity of tactile feedback.

It is another object of the invention to provide a keyswitch structure with a sound-generating unit that can be selectively located at an interference position or a non-interference position to meet the needs of users for different operations.

In an embodiment, the invention provides a keyswitch structure including: a keycap, a baseplate disposed below the keycap, a support mechanism connected between the keycap and the baseplate, the support mechanism including a first frame and a second frame pivotally coupled to each other, the first frame having a shaft hole configured to define a shaft, the shaft configured to be rotatably coupled to the keycap, a cam portion disposed on the keycap or the first frame, the cam portion extending toward the baseplate, a restoring member disposed between the keycap and the baseplate and configured to provide a restoring force to enable the keycap to move away from the baseplate, and a sound-generating unit disposed corresponding to the cam portion, the sound-generating unit including a holder and a sound-generating member mounted on the holder, the holder having an impact portion, the sound-generating member having an extending arm extending corresponding to the impact portion, wherein in a plane view, the extending arm is located at an inner side of the first frame and at an outer side of an inner edge of the shaft hole, and wherein when the keycap moves toward the baseplate to drive the support mechanism to move, the cam portion presses the extending arm downward, and then the extending arm is released from the downward pressing of the cam portion and bounces upward to hit the impact portion to generate a sound.

In another embodiment, the invention provides a keyswitch structure including: a keycap having two coupling members, a baseplate disposed below the keycap, a support mechanism connected between the keycap and the baseplate, the support mechanism including a first frame and a second frame pivotally coupled to each other, a cam portion disposed on the keycap or the first frame, the cam portion extending toward the baseplate, a restoring member disposed between the keycap and the baseplate and configured to provide a restoring force to enable the keycap to move away from the baseplate, and a sound-generating unit disposed corresponding to the cam portion, the sound-generating unit including a holder and a sound-generating member mounted on the holder, the holder having an impact portion, the sound-generating member having an extending arm extending corresponding to the impact portion, wherein in a plane view, the extending arm is located in a region defined by an inner virtual connecting line of inner edges of the two coupling members and an outer virtual connecting line of outer edges of the two coupling members, and wherein when the keycap moves toward the baseplate to drive the support mechanism to move, the cam portion presses the extending arm downward, and then the extending arm is released from the downward pressing of the cam portion and bounces upward to hit the impact portion to generate a sound.

In an embodiment, the first frame is pivotally coupled to an inner side of the second frame to define a pivotal axial line. The restoring member is disposed deviating from the pivotal axial line toward a direction away from the sound-generating unit.

In yet another embodiment, the invention provides a keyswitch structure, including: a keycap, a baseplate disposed below the keycap, a support mechanism connected between the keycap and the baseplate, the support mechanism including a first frame and a second frame pivotally coupled to each other to define a pivotal axial line, a cam portion disposed on the keycap or the first frame, the cam portion extending toward the baseplate, a restoring member disposed between the keycap and the baseplate and deviating from the pivotal axial line, the restoring member configured to provide a restoring force to enable the keycap to move away from the baseplate, and a sound-generating unit disposed corresponding to the cam portion, the sound-generating unit including a holder and a sound-generating member mounted on the holder, the holder having an impact portion, the sound-generating member having an extending arm extending corresponding to the impact portion, wherein when the keycap moves toward the baseplate to drive the support mechanism to move, the cam portion presses the extending arm downward, and then the extending arm is released from the downward pressing of the cam portion and bounces upward to hit the impact portion to generate a sound.

In an embodiment, the holder is movable relative to the baseplate, so the sound-generating unit is selectively located at an interference position or a non-interference position. When the sound-generating unit is located at the interference position, the extending arm is pressed by the cam portion to generate the sound. When the sound-generating unit is located at the non-interference position, the extending arm is not pressed by the cam portion and does not generate the sound.

In an embodiment, the baseplate has an opening. The sound-generating unit further includes an adjustment plate disposed below the baseplate. The holder is disposed on the adjustment plate and protrudes above the baseplate from the opening.

In an embodiment, the baseplate has a guiding rib. The holder protrudes above the baseplate from the opening and at least partially located below the guiding rib. The guiding rib guides a movement of the holder relative to the baseplate.

In an embodiment, the keyswitch structure further includes a restricting member and a restricting groove. The restricting member is disposed on one of the baseplate and the adjustment plate. The restricting groove is disposed on the other of the baseplate and the adjustment plate. When the adjustment plate drives the holder to move relative to the baseplate, the restricting member relatively moves in the restricting groove.

In an embodiment, the keyswitch structure further includes a smooth film disposed between the adjustment plate and the baseplate. The smooth film has a friction coefficient smaller than a friction coefficient of the adjustment plate.

In an embodiment, the keyswitch structure further includes a circuit membrane. The circuit membrane has a film hole disposed corresponding to the holder. The film hole has a size is twice larger than a bottom area of the holder.

Compared to the prior art, the keyswitch structure of the invention takes the upward force of the sound-generating member and the restoring force of the restoring member into consideration during the design of the interference position of the sound-generating member, so the keyswitch structure can provide not only the sound feedback, but also a more uniform tactile feedback throughout the keycap. Moreover, the keyswitch structure of the invention can move the holder with the entire sound-generating member mounted thereon, to prevent deformation of the sound-generating member during the process of adjusting the sound feedback, further to meet the needs of users for different operations.

### BRIEF DESCRIPTION OF THE DRAWINGS

FIG. 1 is a schematic exploded view of a first embodiment of the keyswitch structure of the invention.

FIG. 2A is a schematic plane view of the keyswitch structure of FIG. 1 without the keycap.

FIG. 2B is a schematic simplified view of the position of the sound-generating unit of FIG. 1.

FIGS. 3 and 4 are schematic cross-sectional views of the keyswitch structure of FIG. 1 at the non-pressed state and the pressed state, respectively.

FIG. 5 is a schematic view of the relative position of the sound-generating unit and the baseplate of the keyswitch structure in an embodiment of the invention.

FIGS. 6A to 6C are a schematic exploded view, a schematic assembled view, and a bottom view of the sound-generating unit of the keyswitch structure in an embodiment of the invention, respectively.

FIG. 7A is a schematic plane view of a second embodiment of the keyswitch structure without the keycap.

FIG. 7B is a schematic simplified view of the position of the sound-generating unit of FIG. 7A.

FIG. 8 is a schematic cross-sectional view of the keyswitch structure of FIG. 7A at the non-pressed state.

FIG. 9 is a schematic plane view of a third embodiment of the keyswitch structure without the keycap.

FIG. 10 is a schematic cross-sectional view of the keyswitch structure of FIG. 9 at the non-pressed state.

FIG. 11 is a schematic plane view of a fourth embodiment of the keyswitch structure without the keycap.

FIG. 12 is a schematic cross-sectional view of the keyswitch structure of FIG. 11 at the non-pressed state.

FIG. 13 is a schematic plane view of a fifth embodiment of the keyswitch structure without the keycap.

FIG. 14 is a schematic cross-sectional view of the keyswitch structure of FIG. 13 at the non-pressed state.

FIG. 15 is a schematic top view of the support mechanism of the keyswitch structure of FIG. 13.

FIG. 16 is a schematic bottom view of the support mechanism of the keyswitch structure of FIG. 13.

FIGS. 17A and 17B are schematic views of an embodiment of the restricting member and the restricting groove of the keyswitch structure at different relative positions, respectively.

### DETAILED DESCRIPTION OF THE PREFERRED EMBODIMENT

The invention provides a keyswitch structure, particularly a keyswitch structure capable of providing a pressing sound and a more uniform tactile feedback. Specifically, the keyswitch structure can be applied to independent keyboards or integrated into electronic devices to provide the sound feedback and uniform tactile feedback, but not limited thereto.

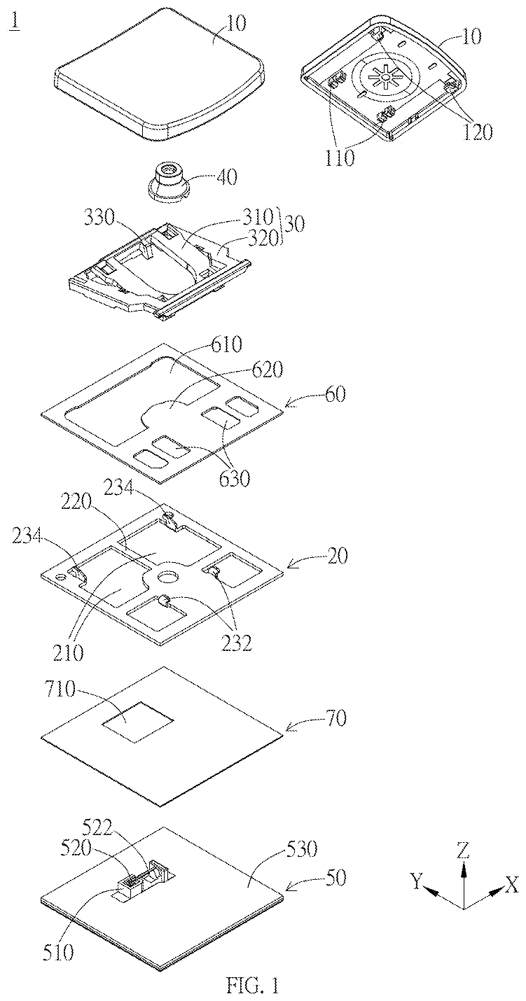

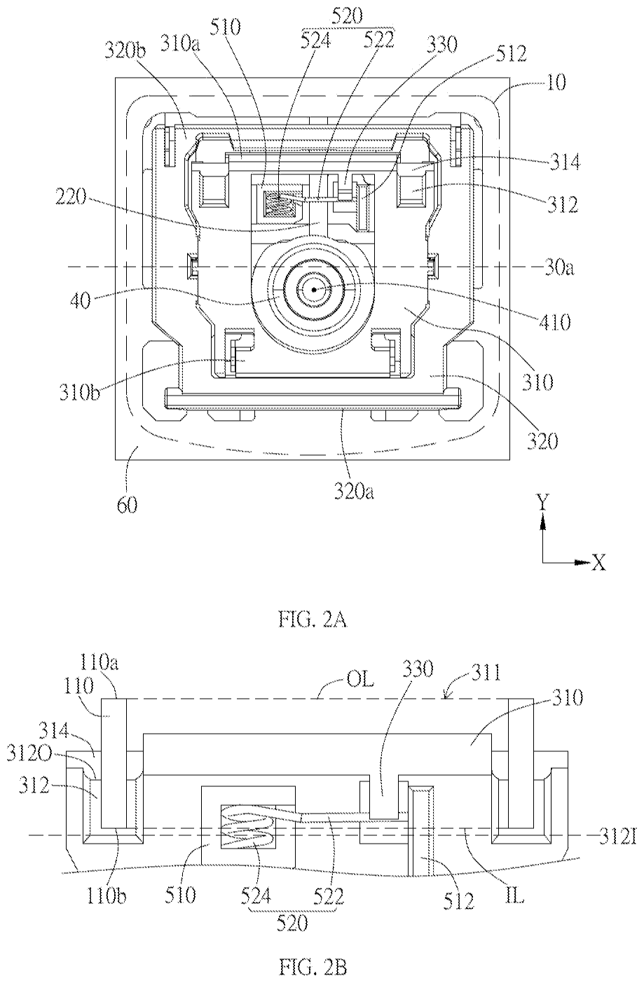

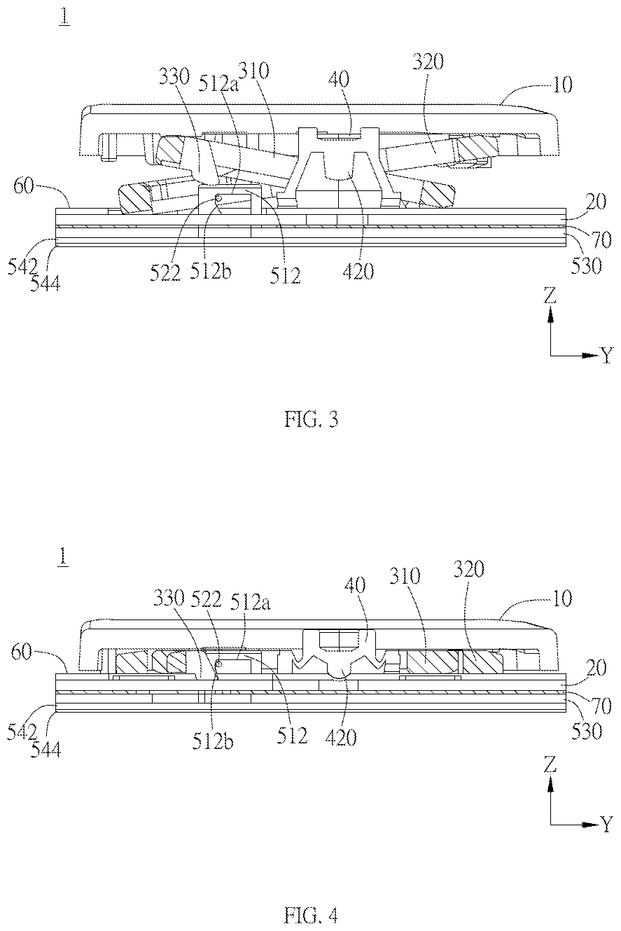

Referring to FIG. 1 to FIG. 4, FIG. 1 is a schematic exploded view of a first embodiment of the keyswitch structure of the invention, FIG. 2A is a schematic plane view of the keyswitch structure of FIG. 1 without the keycap, FIG. 2B is a schematic simplified view of the position of the sound-generating unit of FIG. 1, and FIGS. 3 and 4 are schematic cross-sectional views of the keyswitch structure of FIG. 1 at the non-pressed state and the pressed state, respectively. As shown in FIG. 1 to FIG. 4, the keyswitch structure 1 includes a keycap 10, a baseplate 20, a support mechanism 30, a restoring member 40, and a sound-generating unit 50.

Specifically, the keycap 10 can be a rectangular keycap, and the keycap 10 has coupling members 110 and 120, which are configured to couple to the support mechanism 30. The coupling member 110 and the coupling member 120 extend downward from the bottom surface of the keycap 10 and are disposed apart from each other in the Y-axis direction. For example, the coupling member 110 can be a coupling structure having a coupling hole, such as a claw structure, and two coupling members 110 are disposed apart from each other in the X-axis direction and configured to be coupled to the first frame 310 of the support mechanism 30. The coupling member 120 can be a coupling structure having a groove, and two coupling members 120 are spaced apart from each other in the X-axis direction and configured to be coupled to the second frame 320 of the support mechanism 30. Moreover, according to practical applications, the keycap 10 can be a keycap having a light-transparent portion, so as to be applied to an illuminated keyboard. For example, the light-transparent portion can have an alphanumeric configuration, such as number, letter, and symbol, to indicate the instruction inputted by the keyswitch.

The baseplate 20 is disposed below the keycap 10 and configured to enhance the structural strength of the keyswitch structure 1. The baseplate 20 has connection members 232 and 234, which are configured to connect the support mechanism 30. In an embodiment, the baseplate 20 is preferably a metal plate, which is formed by stamping. The connection members 232 and 234 are hook-like portions bent from the baseplate 20 toward the keycap 10. The baseplate 20 further has an opening 210, which is configured to accommodate the sound-generating unit 50. In this embodiment, the opening 210 is opened toward the moving direction of the keycap 10. For example, the opening 210 penetrates the baseplate 20 along the Z-axis direction. The baseplate 20 may further have a guiding rib 220, which is configured to guide the movement of the sound-generating unit 50 relative to the baseplate 20 and enhances the structural strength of the baseplate 20. For example, the guiding rib 220 can be disposed in the opening 210, and the extending direction of the guiding rib 220 is preferably substantially parallel to the moving direction of the sound-generating unit 50, such as the Y-axis direction.

The support mechanism 30 is connected between the keycap 10 and the baseplate 20 and configured to stably support the keycap 10 to move relative to the baseplate 20. The support mechanism 30 can include a first frame 310 and a second frame 320. The first frame 310 is pivotally coupled to the second frame 320. In this embodiment, the first frame 310 and the second frame 320 are preferably embodied as rectangular frames formed by injection molding. The first frame 310 is pivotally coupled to the inner side of the second frame 320 to form a scissors-like support mechanism. From another aspect, since the first frame 310 is connected to the inner side of the second frame 320, the first frame 310 and the second frame 320 can be referred as an inner frame and an outer frame, respectively. In this embodiment, as shown in the plane view of FIG. 2A, the first frame 310 preferably has a frame size smaller than that of the second frame 320, so the first frame 310 can be completely disposed within the inner side of the second frame 320. In other words, in the Z-axis direction, the first frame 310 and the second frame 320 preferably do not overlap with each other. In an embodiment, the first frame 310 and the second frame 320 can be rotatably connected to each other by means of a pivotal shaft and a pivotal hole to define a pivotal axial line 30a. For example, the pivotal axial line 30a can be a virtual line connecting the pivotal shafts between the first frame 310 and the second frame 320 on two sides of the X-axis direction. In an embodiment, the pivotal axial line 30a preferably overlaps the middle line of the keycap 10. For example, the pivotal axial line 30a is parallel to the X-axis direction and overlaps the virtual connecting line of the midpoints of two sides of the keycap 10 in the Y-axis direction (i.e., Y-axis middle line, which is parallel to the X-axis direction), but not limited thereto.

Two ends of each of the first frame 310 and the second frame 320 are movably connected to the keycap 10 and the baseplate 20, respectively. Specifically, the first frame 310 has a keycap end 310a and a baseplate end 310b, which can be, for example, two opposite ends of the first frame 310 in the Y-axis direction. The keycap end 310a of the first frame 310 is rotatably coupled to the coupling members 110 of the keycap 10, and the baseplate end 310b of the first frame 310 is movably coupled to the connection members 232 of the baseplate 20. Similarly, the second frame 320 has a keycap end 320a and a baseplate end 320b, which can be, for example, two opposite ends of the second frame 320 in the Y-axis direction. The keycap end 320a of the second frame 320 is movably coupled to the coupling members 120 of the keycap 10, and the baseplate end 320b of the second frame 320 is movably coupled to the connection members 234 of the baseplate 20. As such, the support mechanism 30 can stably support the keycap 10 to move upward and downward relative to the baseplate 20. In an embodiment, the first frame 310 can have a shaft hole 312 to define a shaft 314. The shaft 314 is rotatably coupled to the coupling member 110 in a form of shaft hole of the keycap 10. Specifically, the shaft hole 312 is a through hole disposed close to the keycap end 310a of the first frame 310, so the frame edge portion adjacent to the shaft hole 312 becomes the shaft 314. The shaft hole 312 has an inner edge 312I and an outer edge 312O. The inner edge 312I is closer to the pivotal axial line 30a than the outer edge 312O is. From another aspect, the outer edge 312O is farther away from the center of the keycap 10 than the inner edge 312I is, or the outer edge 312O is closer to the outer side of the keycap end 310a of the first frame 310 than the inner edge 312I is. In an embodiment, the shaft hole 312 preferably has a size (e.g. the distance between the inner edge 312I and the outer edge 312O) corresponding to the size of the coupling member 110, so when the coupling member 110 is rotatably coupled to the shaft 314, the coupling member 110 can partially extend into the shaft hole 312 to couple with the shaft 314 by means of the shaft hole of the coupling member 110. Taking the coupling member 110 having the claw structure as an example, the size of the shaft hole 312 is preferably large enough to allow part of the claw portion of the coupling member 110 to extend thereinto to rotatably clamp the shaft 314.

Moreover, the first frame 310 is provided with a cam portion 330. The cam portion 330 is disposed on the inner side of the first frame 310 and extends from the first frame 310 toward the baseplate 20. For example, the cam portion 330 is preferably disposed on the inner side of the keycap end 310a of the first frame 310. The cam portion 330 can be a downward-extending angular post, and the protrudent point thereof preferably protrudes toward the sound-generating unit 50. For example, the cam portion 330 can be an angular post having a lower surface and an upper surface inclined toward each other and connected at the protrudent point. The protrudent point is preferably rounded and protrudes toward the inner side of the keycap 10 (e.g. toward the pivotal axial line 30a).

The restoring member 40 is disposed between the keycap 10 and the baseplate 20 and configured to provide a restoring force to enable the keycap 10 to move away from the baseplate 20. The restoring member 40 can be a rubber dome, a coil spring, or a magnetic member, which provides the restoring force to enable the keycap 10 to move away from the baseplate 20. In this embodiment, the restoring member 40 is embodied as the rubber dome and has a triggering portion 420. In an embodiment, the restoring member 40 is preferably disposed deviating from the pivotal axial line 30a toward a direction away from the sound-generating unit 50. Specifically, as shown in FIG. 2A, the center 410 (or the centroid) of the restoring member 40 and the sound-generating unit 50 are preferably located at two opposite sides with respect to the pivotal axial line 30a (or the middle line of the keycap 10) in the Y-axis direction, but not limited thereto.

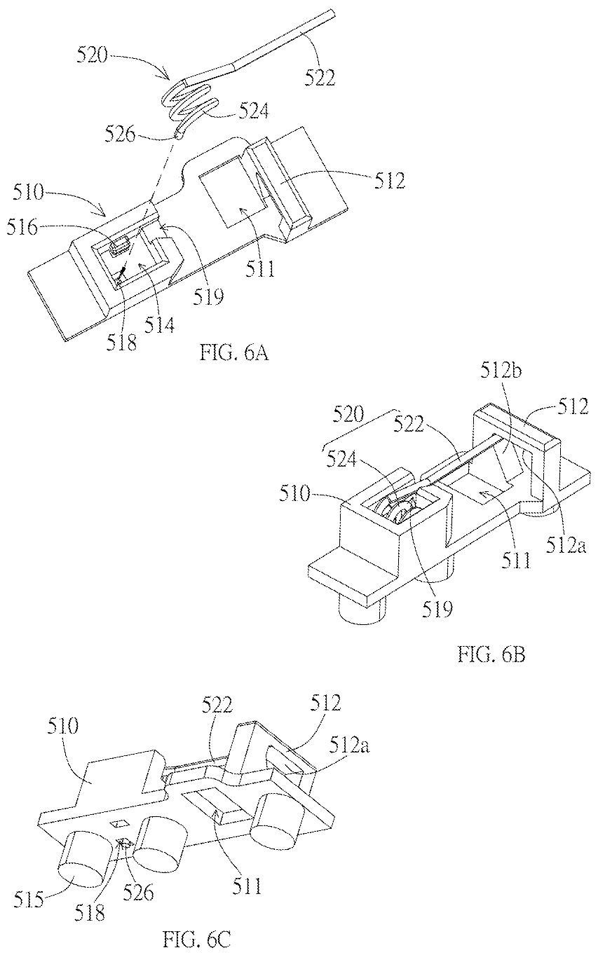

The sound-generating unit 50 is disposed corresponding to the cam portion 330 and configured to provide tactile feedback and sound feedback as the keyswitch structure 1 is pressed. As shown in FIG. 6A to FIG. 6C, in an embodiment, the sound-generating unit 50 includes a holder 510 and a sound-generating member 520. The sound-generating member 520 is mounted on the holder 510 and has an extending arm 522. The holder 510 has an impact portion 512. The extending arm 522 extends corresponding to the impact portion 512. Specifically, the sound-generating member 520 can be a torsion spring, which includes a spring body 524, and the extending arm 522 extends from one end of the spring body 524. The sound-generating member 520 can further have a positioning portion 526, which extends from the other end of the spring body 524. For example, the positioning portion 526 and the extending arm 522 can be rod portions that extend from two opposite ends of the spring body 524. The extending arm 522 can function as a movable portion of the sound-generating member 520, and the spring body 524 and the positioning portion 526 can be regarded as the immovable portion of the sound-generating member 520. The holder 510 may have a positioning mechanism, which is configured to position the sound-generating member 520. For example, the positioning mechanism can include a receiving space 514, a positioning block 516, a positioning hole 518, and a positioning slot 519, which are configured to receive and position the spring body 524, the positioning portion 526, and the extending arm 522, respectively. Specifically, the holder 510 can be a rectangular body with the receiving space 514 and extends along the X-axis direction. The positioning hole 518 is formed as a through hole on the bottom of the holder 510 and communicates with the receiving space 514. The positioning block 516 is disposed on the wall surface, which defines the receiving space 514, and extends toward the receiving space 514. In an embodiment, the positioning block 516 and the positioning hole 518 are preferably located in the receiving space 514 at two opposite sides along the Y-axis direction. The positioning slot 519 is disposed on the extending path of the extending arm 522 to limit the lateral movement of the extending arm 522. When the sound-generating member 520 is disposed in the receiving space 514 of the holder 510, the positioning portion 526 of the sound-generating member 520 is inserted into the positioning hole 518, the spring body 524 is arranged on the positioning block 516, and the extending arm 522 extends through the positioning slot 519 along the X-axis direction and is partially confined in the positioning slot 519. When the holder 510 is disposed on the baseplate 20, the extending arm 522 preferably extends parallel to the keycap end 310a the first frame 310.

The impact portion 512 of the holder 510 is disposed corresponding to the extending arm 522. The impact portion 512 has an impact surface 512a and an inclined surface 512b. For example, the impact portion 512 can be a frame standing on the holder surface of the holder 510. The impact portion 512 includes a vertical portion and a horizontal portion. The vertical portion extends upward from the holder surface of the holder 510 along the Z-axis direction, and the horizontal portion extends from the top end of the vertical portion along the Y-axis direction. As such, the impact portion 512 can have a reverse “U” shape or an “L” shape (a reverse “U” shaped shown in the drawing). The impact portion 512 is disposed at the other side of the receiving space 514 opposite to the positioning hole 518 (or the positioning block 516), so the horizontal portion of the impact portion 512 is located above the extending arm 522 and overlaps the distal end (free end) of the extending arm 522 in the Z-axis direction. The impact surface 512a is a wall surface of the impact portion 512 that faces the extending arm 522 in the Z-axis direction, such as the lower surface of the horizontal portion, and functions as a surface hit by the extending arm 522. The inclined surface 512b is disposed beside the extending direction (e.g. the X-axis direction) of the extending arm 522 and configured to guide the movement of the extending arm 522 in the Z-axis direction. For example, the inclined surface 512b can be the wall surface of the impact portion 512 that faces the extending arm 522 in the Y-direction, such as the wall surface of the vertical portion adjacent to the impact surface 512a. The inclined surface 512b is preferably inclined, from up to down, toward the pivotal axial line 30a, i.e., inclined toward the center of the keycap 10.

The holder 510 can further include a channel 511 to allow the cam portion 330 to move in the channel 511 corresponding to the extending arm 522. The channel 511 is preferably formed corresponding to the extending arm 522 on the portion of the holder 510 that faces the cam portion 330, so the cam portion 330 can move along the Z-axis direction into the channel 511. The channel 511 can be formed on the holder 510 as a through hole with or without an open end. In other words, the channel 511 is formed through the holder 510 and can extend or not extend to the side edge of the holder 510.

Moreover, the keyswitch structure 1 can further include a switch unit. In this embodiment, the switch unit can be embodied as a circuit membrane 60, which is disposed under the rubber dome (i.e., the restoring member 40), and located under or above the baseplate 20 (in this embodiment, above), but not limited thereto. In another embodiment, the switch unit can be an optical switch or a mechanical switch, which is triggered to generate a triggering signal in response to the movement of the keycap 10 relative to the baseplate 20. The circuit membrane 60 has a switch element 620, and the circuit membrane 60 can be a membrane switch having a multi-layer structure. The switch element 620 can be disposed on one or more layers of the multi-layer structure and can be triggered by the triggering portion 420 to generate the triggering signal as the keycap 10 moves downward. Moreover, the circuit membrane 60 has a film hole 610. The film hole 610 is at least partially aligned with the opening 210 of the baseplate 20 and configured to accommodate the sound-generating unit 50. The film hole 610 of the circuit membrane 60 is disposed corresponding to the holder 510. The film hole 610 preferably has a size at least twice larger than the bottom area of the holder 510 to provide a larger moving space for the holder 510, but not limited thereto. The circuit membrane 60 may further have one or more film holes 630 to allow the connection members 232 and 234 of the baseplate 20 to extend therethrough.

As shown in FIG. 3 and FIG. 4, when the keycap 10 moves toward the baseplate 20 to drive the support mechanism 30 to move, the cam portion 330 presses the extending arm 522 downward, and then the extending arm 522 is released from the downward pressing of the cam portion 330 and bounces upward to hit the impact portion 512 to generate a sound. Specifically, When the keycap 10 is pressed, the keycap 10 drives the support mechanism 30 to move downward and compresses the rubber dome (i.e., the restoring member 40), and the cam portion 330 moves along with the support mechanism 30 downward to interfere with the extending arm 522. The cam portion 330 moves toward the channel 511 of the holder 510 and presses the extending arm 522, so the extending arm 522 moves downward along the inclined surface 512b of the impact portion 512 and along the lower surface of the cam portion 330 toward the protrudent point. When the keycap 10 keeps moving downward to trigger the switch element 620 of the circuit membrane 60, the extending arm 522 moves relatively across the protrudent point of the cam portion 330 and then along the upper surface of the cam portion 330, so the extending arm 522 is released to bounce (upward) toward the impact portion 512 of the holder 510 and hit the impact surface 512a of the impact portion 512 to generate the sound. When the keycap 10 is released, i.e., the keycap 10 is not pressed anymore, by means of the restoring force provided by the restoring member 40, the keycap 10 and the support mechanism 30 can move upward relative to the baseplate 20 and return to the non-pressed position shown in FIG. 3.

As shown in FIG. 2A and FIG. 2B, in the plane view, the extending arm 522 is preferably located at the inner side of the first frame 310 and at the outer side of the inner edge 312I of the shaft hole 312 of the first frame 310. From another aspect, in the plane view, the extending arm 522 is located in a region 311 defined by the outer virtual connecting line OL of the outer edges 110a of the two coupling members 110 and the inner virtual connecting line IL of the inner edges 110b of the two coupling members 110. In this embodiment, the position difference of the shaft 314 and the outmost edge of the keycap end 310a of the first frame 310 in the Y-axis direction is very small, so the extending arm 522 can be considered as between the inner edge 312I and the outer edge 312O of the shaft hole 312 of the first frame 310. With such a configuration, the sound-generating unit 50 is disposed relatively close to the pivotal axial line 30a or the middle line of the keycap 10, and in cooperation with the deviation arrangement of the restoring member 40 (i.e., deviation from the pivotal axial line 30a or the Y-axis middle line of the keycap 10), so when the keycap 10 is pressed, the keyswitch structure 1 will have a more balanced tactile feedback at opposite sides in the Y-axis direction or corners of the keycap 10. In other words, with such a configuration, the upward forces of the sound-generating member 520 and the restoring member 40 of the keyswitch structure 1 are configured in a better arrangement, so the keyswitch structure 1 can not only provide the pressing sound feedback, but also have a more uniform tactile feedback throughout the entire keycap.

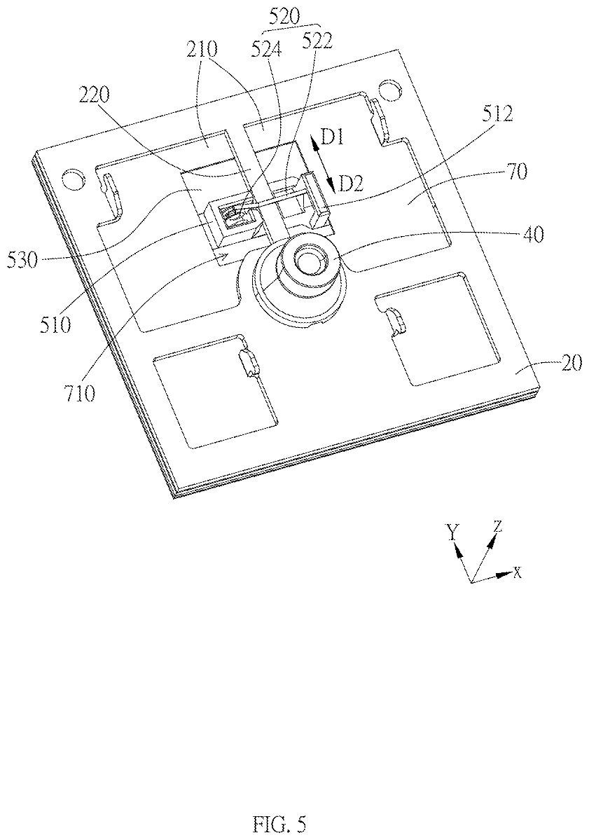

As shown in FIG. 1 to FIG. 5, the sound-generating unit 50 can further include an adjustment plate 530. The adjustment plate 530 is disposed below the baseplate 20. The holder 510 is disposed on the adjustment plate 530 and protrudes above the baseplate 20 from the opening 210. Specifically, the holder 510 has an engaging portion 515, which is configured to couple with the adjustment plate 530. For example, the engaging portion 515 can be a stud or a hook, which is disposed on the bottom of the holder 510 and extends downward. The adjustment plate 530 substantially extends parallel to the baseplate 20 and has one or more holes correspond to the engaging portion 515. When the holder 510 is disposed on the adjustment plate 530, the engaging portion 515 is inserted into the hole of the adjustment plate 530, so the holder 510 is positioned on the adjustment plate 530, but not limited thereto. The holder 510 can be combined with the adjustment plate 530 by any suitable methods, such as screwing, adhering, engaging. When the adjustment plate 530 is disposed below the baseplate 20, the holder 510 can protrude toward the keycap 10 from the opening 210 of the baseplate 20, and the holder 510 is at least partially located below the guiding rib 220 of the baseplate 20, so the guiding rib 220 can guide the movement of the holder 510 relative to the baseplate 20. For example, as shown in FIG. 5, when the adjustment plate 530 is disposed below the baseplate 20, the left portion of the holder 510 (e.g. the portion including the receiving space 514, the positioning block 516, the positioning hole 518, and the positioning slot 519) protrudes above the baseplate 20 from the left opening 210 of the baseplate 20. The right portion of the holder 510 (e.g. the portion including the channel 511 and the impact portion 512) protrudes above the baseplate 20 from the right opening 210 of the baseplate 20. The middle portion of the holder 510 (e.g. the plate portion) is located below the guiding rib 220. When the sound-generating member 520 is mounted on the holder 510, the extending arm 522 extends above and across the guiding rib 220, and the distal end (free end) of the extending arm 522 extends right below the impact portion 512. In other words, the extending direction of the guiding rib 220 is preferably perpendicular to the extending direction of the extending arm 522 and the keycap end 310a of the first frame 310.

The holder 510 is movable relative to the baseplate 20, so the sound-generating member 520 can be selectively located at an interference position or a non-interference position. When the sound-generating member 520 is located at the interference position, the extending arm 522 can be pressed by the cam portion 330 to generate the sound. When the sound-generating member 520 is located at the non-interference position, the extending arm 522 is not pressed by the cam portion 330 and does not generate the sound. As shown in FIG. 5, the adjustment plate 530 is movable relative to the baseplate 20 toward the direction D1 or the direction D2 to drive the holder 510 to move along the guiding rib 220 to approach or move away from the cam portion 330, so the position of the sound-generating member 520 relative to the cam portion 330 is changed, and the extending arm 522 can be located inside or outside the moving path of the cam portion 330. As such, the tactile feedback and the sound effect of the keyswitch structure 1 can be changed. For example, since the sound-generating unit 50 is movable relative to the baseplate 20 (e.g. by moving the adjustment plate 530 to move the holder 510 in the opening 210 relative to the baseplate 20), the sound-generating member 520 mounted on the holder 510 can be located at different positions with respect to the moving path of the cam portion 330. In this embodiment, when the holder 510 moves relative to the baseplate 20 in the opening 210 toward a direction (e.g. direction D1) approaching the cam portion 330, the sound-generating member 520 moves along with the holder 510 to be located inside the moving path of the cam portion 330, i.e., the extending arm 522 extends across the moving path of the cam portion 330, or the extending arm 522 and the cam portion 330 at least partially overlap each other in the Z-axis direction. In such a configuration, the sound-generating member 520 is located at the interference position. When the keycap 10 is pressed, the keycap 10 moves toward the baseplate 20 to drive the support mechanism 30 to move. At the same time, the cam portion 330 presses the extending arm 522 downward, and then the extending arm 522 is released from the downward pressing of the cam portion 330 and bounces upward to hit the impact surface 512a of the impact portion 512 to generate the sound.

When the holder 510 moves relative to the baseplate 20 in the opening 210 toward a direction (e.g. direction D2) away from the cam portion 330, the sound-generating member 520 moves along with the holder 510 to be located outside of the moving path of the cam portion 330, i.e., the extending arm 522 moves away from the moving path of the cam portion 330, or the extending arm 522 does not overlap the cam portion 330 in the Z-axis axis direction. In such a configuration, the sound-generating member 520 is located at the non-interference position. When the keycap 10 is pressed to drive the support mechanism 30 and the cam portion 330 to move downward and compresses the rubber dome (i.e., the restoring member 40) to trigger the switch element 620 of the circuit membrane 60, since the extending arm 522 is located outside the moving path of the cam portion 330, the cam portion 330 does not interfere with the extending arm 522, so the keyswitch structure 1 provides a soundless linear tactile feedback. In such a status, the keyswitch structure 1 requires less pressing force for the cam portion 330 to move across the sound-generating member 520, and no sound will be generated.

Moreover, as shown in FIG. 1 to FIG. 5, the keyswitch structure 1 can further include a smooth film 70. The smooth film 70 is disposed between the adjustment plate 530 and the baseplate 20. The smooth film 70 has a friction coefficient is smaller than that of the adjustment plate 530. For example, the smooth film 70 can be a Teflon film, which preferably has a super low friction coefficient, such as equal to or smaller than 0.1, so the adjustment plate 530 can easily move relative to the baseplate 20, but not limited thereto. The smooth film 70 can be made of any low friction coefficient materials as appropriate to facilitate the movement of the adjustment plate 530 relative to the baseplate 20. In this embodiment, the smooth film 70 has a window 710, and the window 710 is disposed corresponding to the holder 510. When the smooth film 70 is disposed on the adjustment plate 530, the holder 510 can pass through the window 710 of the smooth film 70 to be disposed on the adjustment plate 530.

As shown in FIG. 3, the keyswitch structure 1 can optionally include one or more films 542, 544, which are configured to enhance the protection and/or the waterproof performance of the keyswitch structure 1. For example, the keyswitch structure 1 can be provided with Mylar insulation film (e.g. 542) and/or Mylar waterproof film (e.g. 544) under the adjustment plate 530, but not limited thereto.

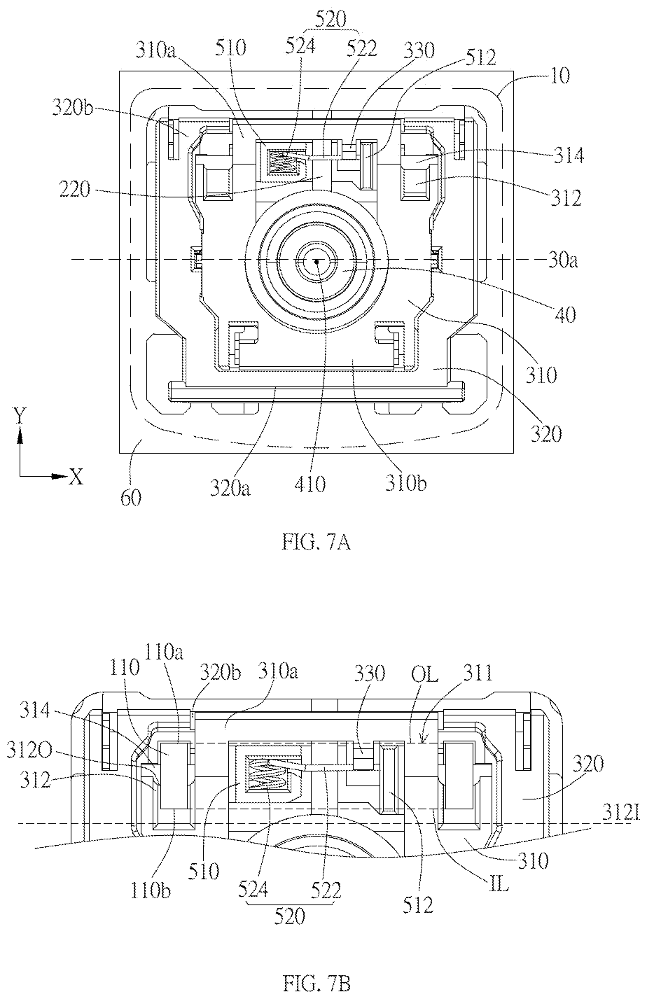

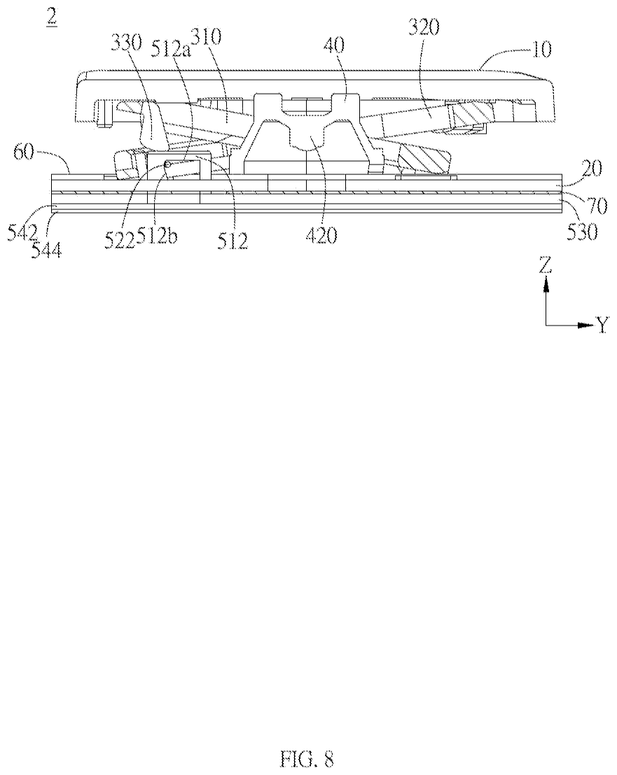

Referring to FIG. 7A to FIG. 8, FIG. 7A is a schematic plane view of a second embodiment of the keyswitch structure without the keycap, FIG. 7B is a schematic simplified view of the position of the sound-generating unit of FIG. 7A, and FIG. 8 is a schematic cross-sectional view of the keyswitch structure of FIG. 7A at the non-pressed state. As shown in FIG. 7A to FIG. 8, the keyswitch structure 2 in this embodiment is similar to the keyswitch structure 1 of the first embodiment. For example, the details of the keycap 10, the baseplate 20, the restoring member 40, and the sound-generating unit 50 can be referred to the related descriptions of the previous embodiments. Hereinafter, the difference of the keyswitch structure 2 of FIG. 7A and the keyswitch structure 1 of FIG. 1 will be described.

In this embodiment, the keycap end 310a of the first frame 310 of the support mechanism 30 protrudes further outward relative to the shaft 314. When the first frame 310 is pivotally coupled to the inner side of the second frame 320, in the plane view, the keycap end 310a of the first frame 310 at least partially overlaps the baseplate end 320b of the second frame 320. From another aspect, in the Z-axis direction, the keycap end 310a of the first frame 310 at least partially overlaps the baseplate end 320b of the second frame 320, so the first frame 310 has a larger space for arranging the sound-generating unit 50. Similar to the first embodiment, in the plane view, the extending arm 522 is located at the inner side of the first frame 310 and at the outer side of the inner edge 312I of the shaft hole 312 of the first frame 310. From another aspect, in the plane view, the extending arm 522 is located in the region 311 defined by the outer virtual connecting line OL of the outer edges 110a of the two coupling members 110 and the inner virtual connecting line IL of the inner edges 110b of the two coupling members 110. In this embodiment, since the position difference of the shaft 314 and the outmost edge of the keycap end 310a of the first frame 310 in the Y-axis direction is relatively larger, the extending arm 522 can be regarded as in the region 311. With such a configuration, the sound-generating unit 50 can be disposed farther from the pivotal axial line 30a or the middle line of the keycap 10 to provide sufficient room for centrally disposing the restoring member 40 (i.e., the center (or centroid) overlaps the pivotal axial line 30a or the middle line of the keycap 10), so the keyswitch structure 2 can provide not only the sound feedback, but also a relatively uniform tactile feedback throughout the keycap. Compared to the keyswitch structure 1, the keyswitch structure 2 has a less uniform tactile feedback at opposite sides in the Y-axis direction or corners of the keycap 10.

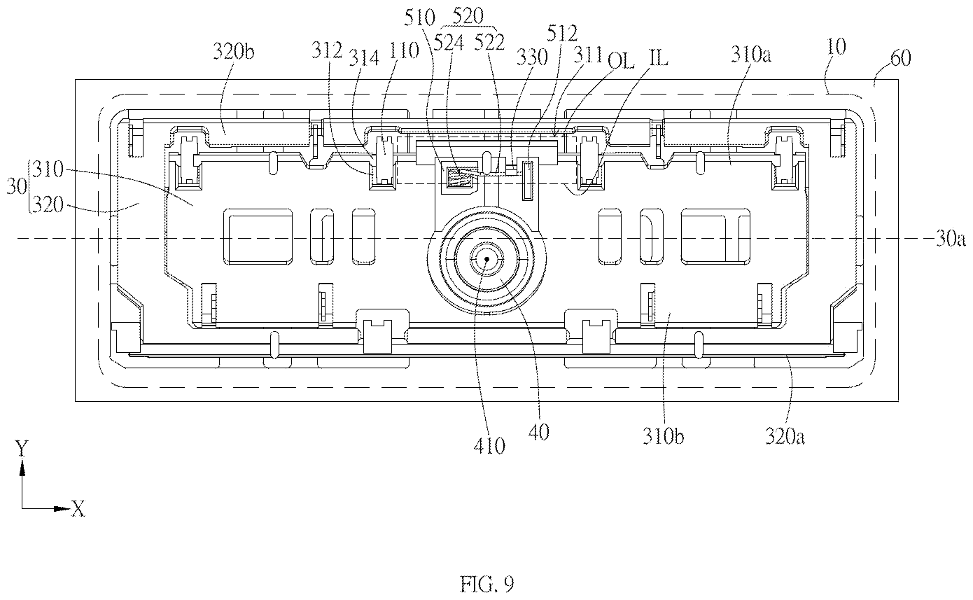

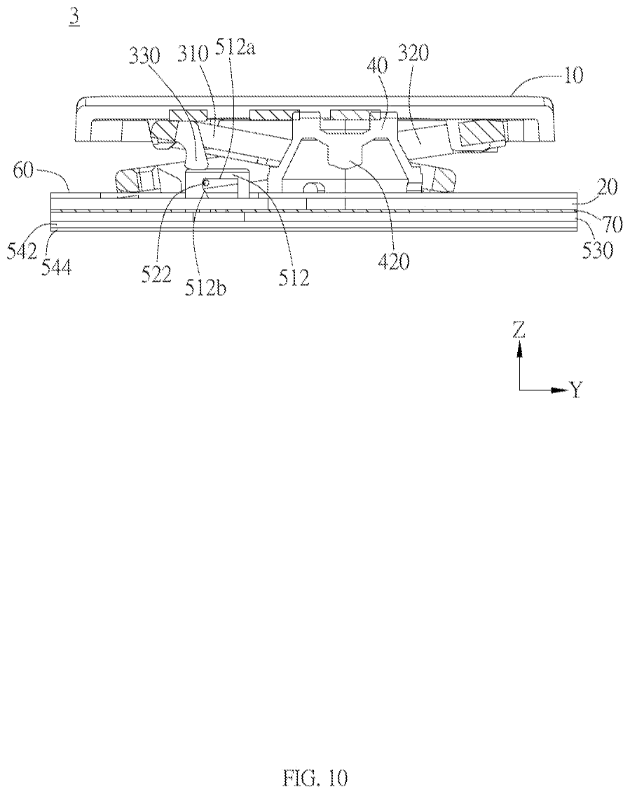

Referring to FIG. 9 and FIG. 10, FIG. 9 is a schematic plane view of a third embodiment of the keyswitch structure without the keycap, and FIG. 10 is a schematic cross-sectional view of the keyswitch structure of FIG. 9 at the non-pressed state. As shown in FIG. 9 and FIG. 10, the keyswitch structure 3 in this embodiment is similar to the keyswitch structure 1 of the first embodiment. For example, the details of the keycap 10, the baseplate 20, the restoring member 40, and the sound-generating unit 50 can be referred to the related descriptions of the previous embodiments. Hereinafter, the difference of the keyswitch structure 3 of FIG. 9 and the keyswitch structure 1 of FIG. 1 will be described.

The keyswitch structure 3 is a multiple key, such as “tab”, “shift”, “enter”, “capslock”, “backspace” keys. In this embodiment, the first frame 310 of the support mechanism 30 is a rectangular plate with an off-center hole in the middle portion. The off-center hole is configured to accommodate the restoring member 40. The second frame 320 of the support mechanism 30 is a rectangular frame and has a size larger than that of the first frame 310. When the first frame 310 is pivotally coupled to the inner side of the second frame 320, the first frame 310 having the rectangular plate shape can be completely located within the inner side of the second frame 320, but not limited thereto. In another embodiment, the first frame 310 of the keyswitch structure 3 can have a design similar to FIG. 7A that the keycap end 310a of the first frame 310 partially overlaps the baseplate end 320b of the second frame 320. Regardless of whether the first frame 310 and the second frame 320 partially overlap, the total equivalent forces of the restoring force of the restoring member 40 and the upward bouncing force of the sound-generating member 520 is preferably designed to be close to the pivotal axial line 30a or the middle line of the keycap 10. In cooperation with the deviation arrangement of the restoring member 40 (i.e., deviation from the pivotal axial line 30a or the middle line of the keycap 10), the keyswitch structure 3 will have a more balanced tactile feedback at opposite sides in the Y-axis direction or corners of the keycap 10, so the keyswitch structure 3 can not only provide the pressing sound feedback, but also have a more uniform tactile feedback throughout the entire keycap.

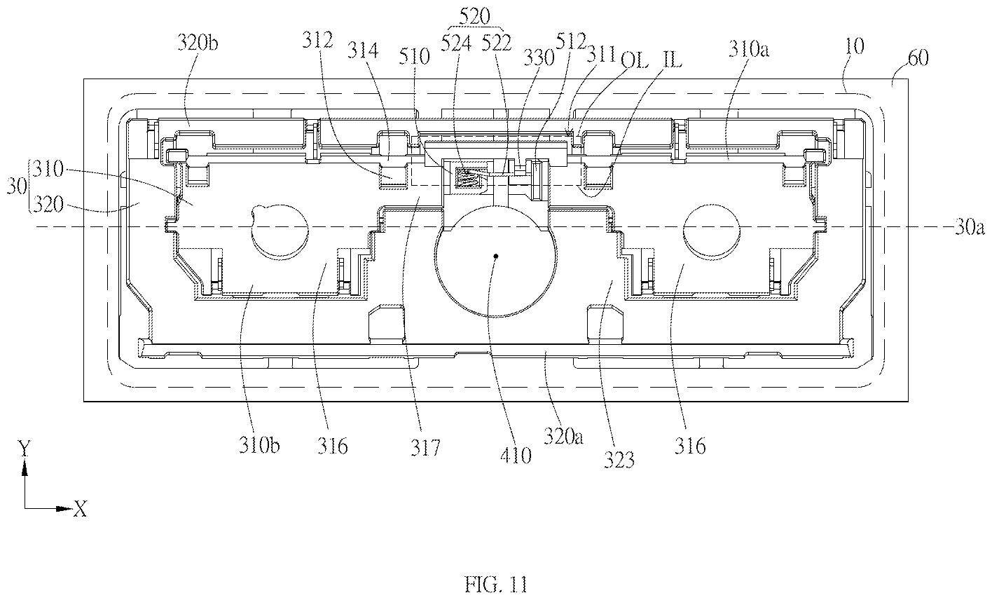

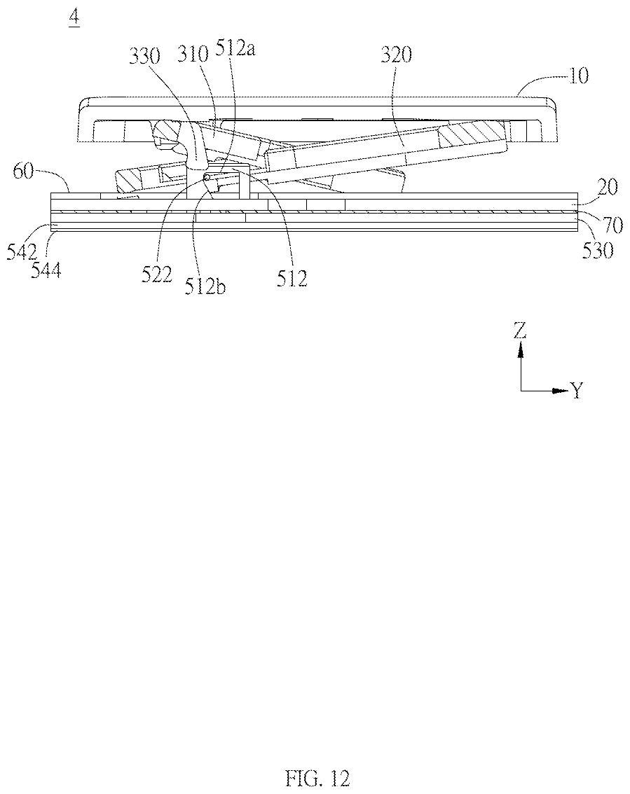

Referring to FIG. 11 and FIG. 12, FIG. 11 is a schematic plane view of a fourth embodiment of the keyswitch structure without the keycap, and FIG. 12 is a schematic cross-sectional view of the keyswitch structure of FIG. 11 at the non-pressed state. As shown in FIG. 11 and FIG. 12, the keyswitch structure 4 in this embodiment is similar to the keyswitch structures 1 to 3 of the previous embodiments. For example, the details of the keycap 10, the baseplate 20, the restoring member 40, and the sound-generating unit 50 can be referred to the related descriptions of the previous embodiments. Hereinafter, the difference of the keyswitch structure 4 of FIG. 11 and the keyswitch structures 1 to 3 of the previous embodiments will be described.

Similar to the keyswitch structure 3 of FIG. 9, the keyswitch structure 4 is a multiple key, such as “tab”, “shift”, “enter”, “capslock”, “backspace” keys. In this embodiment, the first frame 310 of the support mechanism 30 is a glasses shaped plate, which has side portions 316 at two sides and a strip potion 317 at the central portion. The side portion 316 has a larger area and an aspect ratio (i.e., length to width ratio) approximate to 1. The strip potion 317 is connected between the side portions 316 and has an aspect ratio significantly larger or smaller than 1. The holder 510 is disposed corresponding to the strip portion 317 of the first frame 310. The second frame 320 of the support mechanism 30 is a rectangular frame and has a central protrusion 323. In the plane view, the central protrusion 323 is located at the central portion of the second frame 320 and surrounded by the side portions 316 and the strip portion 317. For example, in the plane view, the central protrusion 323 is located between the two side portions 316 and below the strip portion 317. When the first frame 310 is pivotally coupled to the inner side of the second frame 320, the strip portion 317 of the first frame 310 and the central protrusion 323 of the second frame 320 together define the space for arranging the restoring member 40. Similar to the keyswitch structure 1 of the first embodiment, when the first frame 310 is pivotally coupled to the inner side of the second frame 320, the first frame 310 can be completely located within the inner side of the second frame 320, but not limited thereto. In this embodiment, the total equivalent forces of the restoring force of the restoring member 40 and the upward bouncing force of the sound-generating member 520 is preferably designed to be close to the pivotal axial line 30a or the middle line of the keycap 10. In cooperation with the deviation arrangement of the restoring member 40 (i.e., deviation from the pivotal axial line 30a or the middle line of the keycap 10), the keyswitch structure 4 will have a more balanced tactile feedback at opposite sides in the Y-axis direction or corners of the keycap 10, so the keyswitch structure 4 can not only provide the pressing sound feedback, but also have a more uniform tactile feedback throughout the entire keycap.

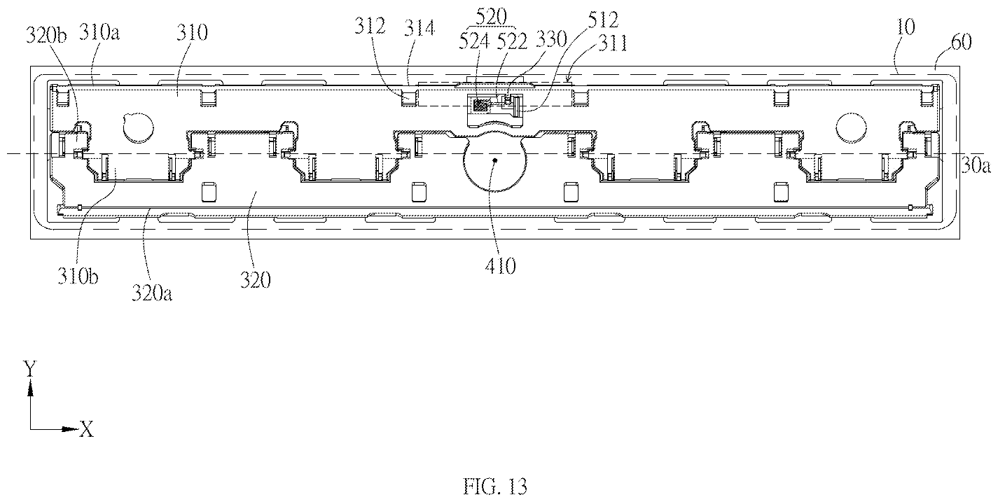

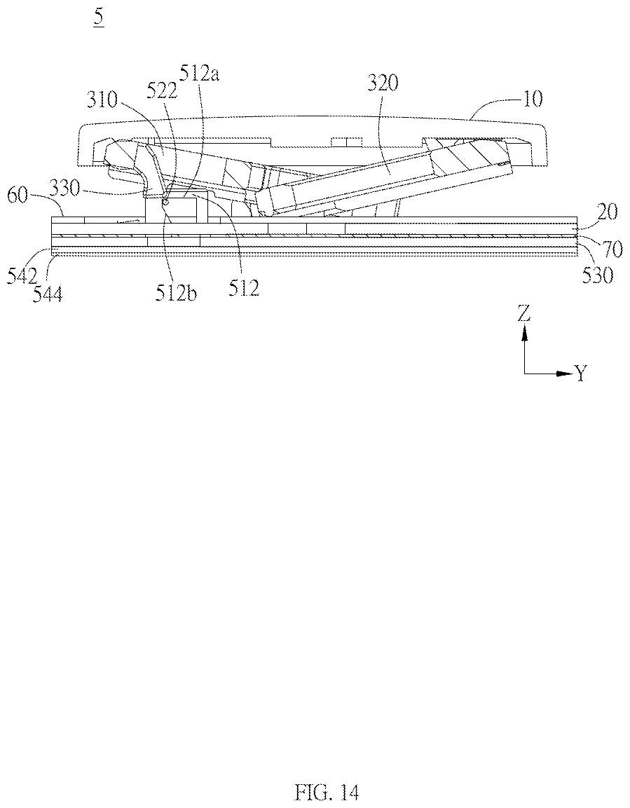

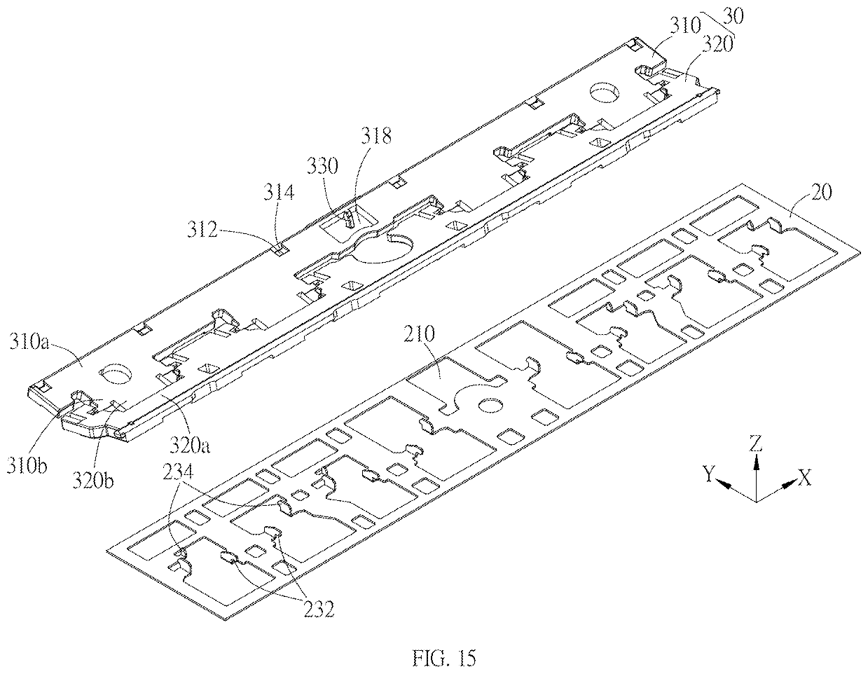

Referring to FIG. 13 and FIG. 14, FIG. 13 is a schematic plane view of a fifth embodiment of the keyswitch structure without the keycap, and FIG. 14 is a schematic cross-sectional view of the keyswitch structure of FIG. 13 at the non-pressed state. As shown in FIG. 13 and FIG. 14, the keyswitch structure 5 in this embodiment is similar to the keyswitch structures 1 to 4 of the previous embodiments. For example, the details of the keycap 10, the baseplate 20, the restoring member 40, and the sound-generating unit 50 can be referred to the related descriptions of the previous embodiments. Hereinafter, the difference of the keyswitch structure 5 of FIG. 13 and the keyswitch structures 1 to 4 of the previous embodiments will be described.

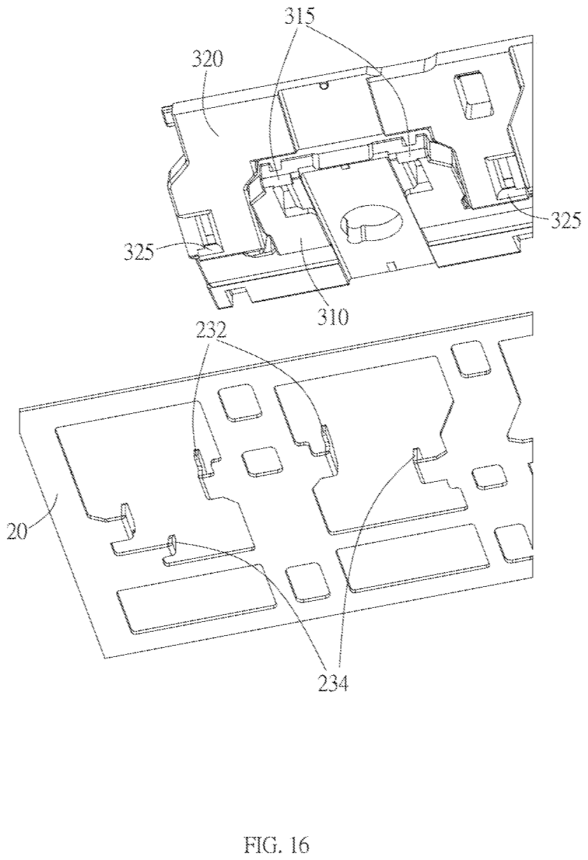

The keyswitch structure 5 is a multiple key, such as “space” key. In this embodiment, the first frame 310 and the second frame 320 of the support mechanism 30 are semi-frame shaped plates. The first frame 310 and the second frame 320 are disposed at two opposite sides of the Y-axis direction. The pivotal axial line 30a of the first frame 310 and the second frame 320 is closer to the baseplate ends 310a, 320b. From another aspect, the distance between the pivotal axial line 30a and the baseplate end 310b (or 320b) is smaller than the distance between the pivotal axial line 30a and the keycap end 310a (or 320a). As shown in FIG. 15 and FIG. 16, the connection members 232, 234 of the baseplate 20 are disposed close to the middle portion of the baseplate 20. Accordingly, the coupling members 315 of the baseplate end 310b of the first frame 310 and the coupling members 325 of the baseplate end 320b of the second frame 320 are coupled to the middle portion of the baseplate 20. When the first frame 310 is pivotally coupled to the inner side of the second frame 320, the first frame 310 and the second frame 320 together define the space for arranging the restoring member 40. For example, a larger portion of the restoring member 40 is substantially surrounded by the second frame 320, and a smaller portion of the restoring member 40 is surrounded by the first frame 310, so the first frame 310 can be formed with an opening 318, which is configured to accommodate the sound-generating unit 50. The cam portion 330 is disposed in the opening 318 adjacent to the keycap end 310a. Similar to the keyswitch structure 1 of the first embodiment, the total equivalent forces of the restoring force of the restoring member 40 and the upward bouncing force of the sound-generating member 520 is preferably designed to be close to the pivotal axial line 30a or the middle line of the keycap 10. In cooperation with the deviation arrangement of the restoring member 40 (i.e., deviation from the pivotal axial line 30a or the middle line of the keycap 10), the keyswitch structure 5 will have a more balanced tactile feedback at opposite sides in the Y-axis direction or corners of the keycap 10, so the keyswitch structure 5 can not only provide the pressing sound feedback, but also have a more uniform tactile feedback throughout the entire keycap.

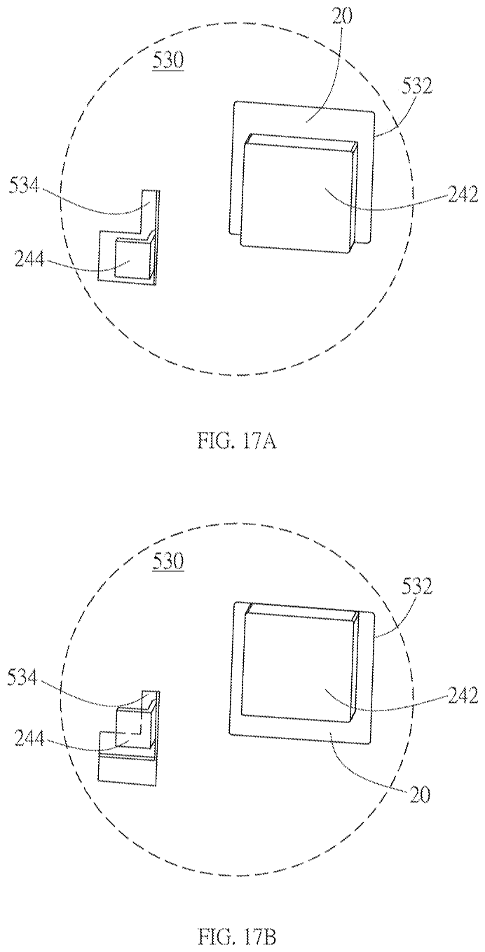

In the previous embodiments, the keyswitch structures 1 to 5 can optionally include a restricting member and a restricting groove. The restricting member is disposed on one of the baseplate 20 and the adjustment plate 530, and the restricting groove is disposed on the other of the baseplate 20 and the adjustment plate 530. When the adjustment plate 530 drives the holder 510 to move relative to the baseplate 20, the restricting member relatively moves in the restricting groove. As shown in FIG. 17A and FIG. 17B, the restricting member can be a rod 242 or a hook 244, and the restricting groove is correspondingly a rod groove 532 or a hook groove 534. For example, when the rod 242 or the hook 244 is formed on the bottom of the baseplate 20, the rod groove 532 or the hook groove 534 is correspondingly formed on the adjustment plate 530. When the rod groove 532 or the hook groove 534 is formed on the baseplate 20, the rod 242 or the hook 244 is correspondingly formed on the top of the adjustment plate 530. When the adjustment plate 530 drives the holder 510 to move relative to the baseplate 20 to position the sound-generating member 520 at the interference position or the non-interference position, the rod 242 moves in the rod groove 532, and/or the hook 244 moves in the hook groove 534, so the movable range of the adjustment plate 530 relative to the baseplate 20 is restricted.

It is noted that in the previous embodiments, the cam portion 330 is exemplarily disposed on the support mechanism 30, but not limited thereto. In another embodiment (not shown), the cam portion 330 can be disposed on the keycap 10, and the cam portion 330 extends downward from the bottom surface of the keycap 10 to correspond to the extending arm 522 of the sound-generating member 520. Moreover, the first frame 310 and the second frame 320 of the support mechanism 30 are preferably made of materials having a stronger rigidity, such as nylon (polyamide) to enhance the resistance of the support mechanism 30 to the upward forces of the restoring member 40 and the sound-generating member 520, thereby reducing the possibility of deformation of the support mechanism 30.

Although the preferred embodiments of the present invention have been described herein, the above description is merely illustrative. The preferred embodiments disclosed will not limit the scope of the present invention. Further modification of the invention herein disclosed will occur to those skilled in the respective arts and all such modifications are deemed to be within the scope of the invention as defined by the appended claims.

What is claimed is:

1. A keyswitch structure, comprising:
a keycap;
a baseplate disposed below the keycap;
a support mechanism connected between the keycap and the baseplate, the support mechanism comprising a first frame and a second frame pivotally coupled to each other, the first frame having a shaft hole configured to define a shaft, the shaft configured to be rotatably coupled to the keycap;
a cam portion disposed on the keycap or the first frame, the cam portion extending toward the baseplate;
a restoring member disposed between the keycap and the baseplate and configured to provide a restoring force to enable the keycap to move away from the baseplate; and
a sound-generating unit disposed corresponding to the cam portion, the sound-generating unit comprising a holder and a sound-generating member mounted on the holder, the holder having an impact portion, the sound-generating member having an extending arm extending corresponding to the impact portion,
wherein in a plane view, the extending arm is located at an inner side of the first frame and at an outer side of an inner edge of the shaft hole,
wherein when the keycap moves toward the baseplate to drive the support mechanism to move, the cam portion presses the extending arm downward, and then the extending arm is released from the downward pressing of the cam portion and bounces upward to hit the impact portion to generate a sound.

2. The keyswitch structure of claim 1, wherein the first frame is pivotally coupled to an inner side of the second frame to define a pivotal axial line; the restoring member is disposed deviating from the pivotal axial line toward a direction away from the sound-generating unit.

3. The keyswitch structure of claim 1, wherein the holder is movable relative to the baseplate, so the sound-generating unit is selectively located at an interference position or a non-interference position; when the sound-generating unit is located at the interference position, the extending arm is pressed by the cam portion to generate the sound; when the sound-generating unit is located at the non-interference position, the extending arm is not pressed by the cam portion and does not generate the sound.

4. The keyswitch structure of claim 1, wherein the baseplate has an opening; the sound-generating unit further comprises an adjustment plate disposed below the baseplate; the holder is disposed on the adjustment plate and protrudes above the baseplate from the opening.

5. The keyswitch structure of claim 4, wherein the baseplate has a guiding rib; the holder protrudes above the baseplate from the opening and at least partially located below the guiding rib; the guiding rib guides a movement of the holder relative to the baseplate.

6. The keyswitch structure of claim 4, further comprising a restricting member and a restricting groove, wherein the restricting member is disposed on one of the baseplate and the adjustment plate; the restricting groove is disposed on the other of the baseplate and the adjustment plate; when the adjustment plate drives the holder to move relative to the baseplate, the restricting member relatively moves in the restricting groove.

7. The keyswitch structure of claim 4, further comprising a smooth film disposed between the adjustment plate and the baseplate; the smooth film has a friction coefficient smaller than a friction coefficient of the adjustment plate.

8. The keyswitch structure of claim 1, further comprising a circuit membrane, wherein the circuit membrane has a film hole disposed corresponding to the holder; the film hole has a size is twice larger than a bottom area of the holder.

9. A keyswitch structure, comprising:
a keycap having two coupling members;
a baseplate disposed below the keycap;
a support mechanism connected between the keycap and the baseplate, the support mechanism comprising a first frame and a second frame pivotally coupled to each other;
a cam portion disposed on the keycap or the first frame, the cam portion extending toward the baseplate;
a restoring member disposed between the keycap and the baseplate and configured to provide a restoring force to enable the keycap to move away from the baseplate; and
a sound-generating unit disposed corresponding to the cam portion, the sound-generating unit comprising a holder and a sound-generating member mounted on the holder, the holder having an impact portion, the sound-generating member having an extending arm extending corresponding to the impact portion,
wherein in a plane view, the extending arm is located in a region defined by an inner virtual connecting line of inner edges of the two coupling members and an outer virtual connecting line of outer edges of the two coupling members,
wherein when the keycap moves toward the baseplate to drive the support mechanism to move, the cam portion presses the extending arm downward, and then the extending arm is released from the downward pressing of the cam portion and bounces upward to hit the impact portion to generate a sound.

10. The keyswitch structure of claim 9, wherein the first frame is pivotally coupled to an inner side of the second frame to define a pivotal axial line; the restoring member is disposed deviating from the pivotal axial line toward a direction away from the sound-generating unit.

11. The keyswitch structure of claim 9, wherein the holder is movable relative to the baseplate, so the sound-generating unit is selectively located at an interference position or a non-interference position; when the sound-generating unit is located at the interference position, the extending arm is pressed by the cam portion to generate the sound; when the sound-generating unit is located at the non-interference position, the extending arm is not pressed by the cam portion and does not generate the sound.

12. The keyswitch structure of claim 9, wherein the baseplate has an opening; the sound-generating unit further comprises an adjustment plate disposed below the baseplate; the holder is disposed on the adjustment plate and protrudes above the baseplate from the opening.

13. The keyswitch structure of claim 12, wherein the baseplate has a guiding rib; the holder protrudes above the baseplate from the opening and at least partially located below the guiding rib; the guiding rib guides a movement of the holder relative to the baseplate.

14. The keyswitch structure of claim 12, further comprising a restricting member and a restricting groove, wherein the restricting member is disposed on one of the baseplate and the adjustment plate; the restricting groove is disposed on the other of the baseplate and the adjustment plate; when the adjustment plate drives the holder to move relative to the baseplate, the restricting member relatively moves in the restricting groove.

15. The keyswitch structure of claim 12, further comprising a smooth film disposed between the adjustment plate and the baseplate; the smooth film has a friction coefficient smaller than a friction coefficient of the adjustment plate.

16. The keyswitch structure of claim 9, further comprising a circuit membrane, wherein the circuit membrane has a film hole disposed corresponding to the holder; the film hole has a size is twice larger than a bottom area of the holder.

17. A keyswitch structure, comprising:
a keycap;
a baseplate disposed below the keycap;
a support mechanism connected between the keycap and the baseplate, the support mechanism comprising a first frame and a second frame pivotally coupled to each other to define a pivotal axial line;
a cam portion disposed on the keycap or the first frame, the cam portion extending toward the baseplate;
a restoring member disposed between the keycap and the baseplate and deviating from the pivotal axial line, the restoring member configured to provide a restoring force to enable the keycap to move away from the baseplate; and
a sound-generating unit disposed corresponding to the cam portion, the sound-generating unit comprising a holder and a sound-generating member mounted on the holder, the holder having an impact portion, the sound-generating member having an extending arm extending corresponding to the impact portion,
wherein when the keycap moves toward the baseplate to drive the support mechanism to move, the cam portion presses the extending arm downward, and then the extending arm is released from the downward pressing of the cam portion and bounces upward to hit the impact portion to generate a sound.

18. The keyswitch structure of claim 17, wherein the holder is movable relative to the baseplate, so the sound-generating unit is selectively located at an interference position or a non-interference position; when the sound-generating unit is located at the interference position, the extending arm is pressed by the cam portion to generate the sound; when the sound-generating unit is located at the non-interference position, the extending arm is not pressed by the cam portion and does not generate the sound.

19. The keyswitch structure of claim 17, wherein the baseplate has an opening; the sound-generating unit further comprises an adjustment plate disposed below the baseplate; the holder is disposed on the adjustment plate and protrudes above the baseplate from the opening.

20. The keyswitch structure of claim 19, wherein the baseplate has a guiding rib; the holder protrudes above the baseplate from the opening and at least partially located below the guiding rib; the guiding rib guides a movement of the holder relative to the baseplate.
